(19) United States
(12) Patent Application Publication
(10) Pub. No.: US 2006/0013001 A1
(43) Pub. Date: Jan. 19, 2006

(54) Reflectors for condensed light beam distribution

(76) Inventor: Karl Frederic Roth, Venice, CA (US)

Correspondence Address: KARL ROTH, P.O. BOX 603, VENICE, CA, 90294, US

(21) Appl. No.: 11/175,086

(22) Filed: Jul. 5, 2005

Related U.S. Application Data
(60) Provisional application No. 60/589,184, filed on Jul. 19, 2004.

(51) Int. Cl. F21V 7/00

(52) U.S. Cl. 362/296

(57) ABSTRACT

A reflector configuration where the reflector surfaces intersect a beam of beam light from least two sides, and are oriented at an angle intersecting the cross section of the propagating beam. The reflectors are further characterized as allowing passage of unreflected portions of the beam to be successively re-directed by other reflectors along the propagating path, where the total lumens reflected and redirected is substantially the same over a given beam propagation distance.

This application claims benefits of the priority filing date for provisional patent No. 60/589/184 filed on Jul. 19, 2004 and titled “Improved Reflectors For Condensed Light Beam Distribution”.

References Cited:
U.S. Patent Documents
6,691,701
4,349,245

### BACKGROUND OF THE INVENTION

1. Field of the Invention

This invention relates to energy distribution, and in particular to illumination devices for concentrated or substantially collimated beam distribution of sunlight or artificial light.

### BACKGROUND INFORMATION

Condensed beam distribution of daylight or artificial light is a conceived yet uncommercialized concept where a beam of concentrated light such as collected by a two axis sun-tracking collector and is distributed with stationary reflectors typically along a ceiling or roof, such as is described in U.S. Pat. No. 4,349,245 (Kliman). Successive portions of a concentrated beam in such a system can be re-directed typically in a downward fashion to provide for building illumination. Also described in U.S. Pat. No. 6,691,701 (Roth), proposed louver type reflectors for such a concept that progressively intersect the uppermost beam sections for this purpose may work adequately for high ceiling warehouses and for short distribution distances where the beam expands minimally, they are not ideal, nor practical for lower ceilings, and longer distance distribution applications.

When utilizing collector optics of practical and cost effective accuracy, the concentrated beam expands in diameter significantly over distance. Because of this expansion, both the beam and prior art reflectors designed to distribute portions of such a beam, both begin an undesirable and impractical incursion into the building workspace.

It is a principal object and advantage of the invention to allow improved distribution of light in a more confined space for a concentrated beam of sunlight or artificial light.

### BRIEF SUMMARY OF THE INVENTION

The invention provides an improved means of re-directing and distributing light from a condensed beam of light in a confined space. Included are a series of reflectors where the reflector surfaces intersect a beam of light from at least two sides, and are oriented at an angle intersecting the cross section of the propagating beam. The reflectors are further characterized as having a configuration allowing passage of un-reflected portions of the beam to be successively re-directed by other reflectors along the path of propagation, and evenly distributing light over a given distance of beam propagation.

### BRIEF DESCRIPTION OF THE DRAWINGS

FIG. 1 is an isometric view of the first reflector embodiment showing the vertical axis light rays.

FIG. 2 is an isometric view of a second reflector embodiment showing the vertical axis light rays.

### DETAILED DESCRIPTION OF THE PREFERRED EMBODIMENTS

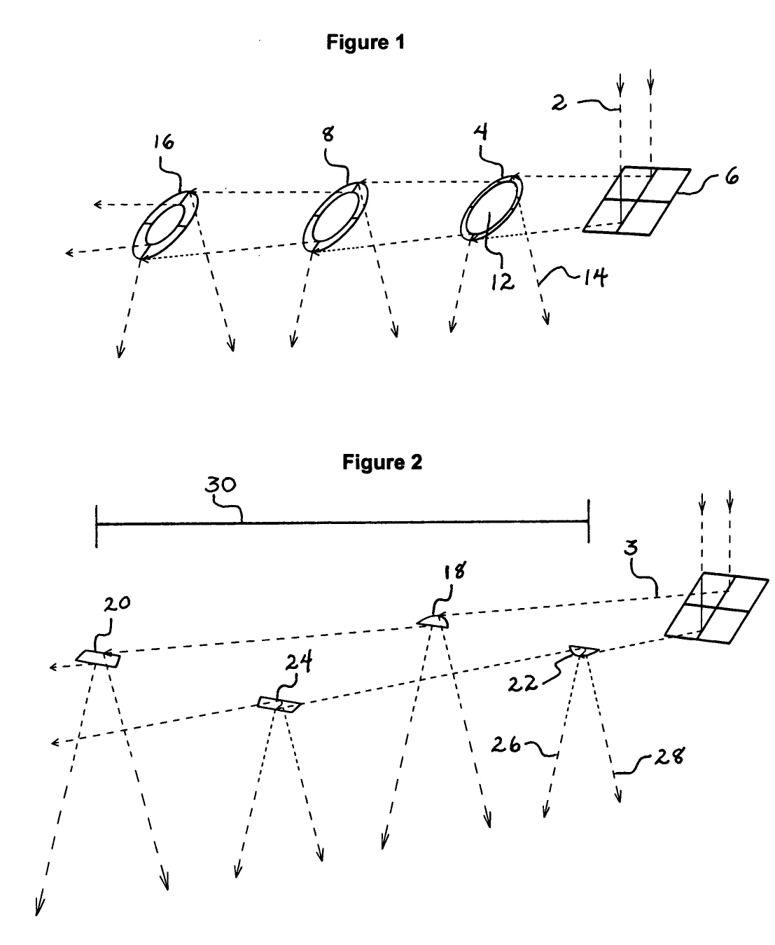

Referring to FIG. 1, the figure shows a moderately expanding condensed light beam 2, intersecting lateral reflector 6. First reflector 4, and aperture 12 are positioned intersecting a cross section of light beam 2. Reflector 4 is positioned at preferably about 45 degrees facing toward the direction of propagation of light beam 2, when downward distribution of the light is desired. Reflector 4 is preferably made of stamped aluminum, and preferably coated with semi gloss white paint. A white painted surface intersecting a beam of condensed light at substantially 45 degrees will evenly disperse the light in a direction generally perpendicular to the direction of light propagation. Other reflective surfaces, including specular, semi-specular and curved surfaces may be utilized, and their unique distribution characteristics derived from observation or state of the art optical engineering programs.

Light ray 14 re-directed from first reflector 4 propagates in a downward direction. Such reflectors 4, 8 and 16 can also be oriented to reflect the light horizontally etc. Portions of light beam 2 propagate through first reflector aperture 12, and expand over distance. The expansion of the beam is an inherent characteristic of the optic errors from the collecting stage, and the subtended angle of the sun, or may be emphasized by intention in the optical design. The preferred beam expansion is about 1-6 degrees. Circumferential portions of light beam 2 intersect second reflector 8 and are re-directed in a downward direction. Where even spacing between reflectors is desired, reflector 8, and a plurality of additional reflectors such as 16 have a greater utilized reflecting surface area than each preceding reflector in the propagation path of light beam 2.

The greater and progressively increasing utilized reflective surface area of successive reflectors is useful and necessary to re-direct substantially the same amount of light as the preceding reflector where even spacing between reflectors is desired, because there is a lesser cross-sectional energy density of the beam as it expands over distance. The increased surface area of each successive reflector is a function of, and can be calculated by the increase in light beam 2 diameter at a given distance and spacing from the previous reflector, and compared to the diameter and energy density of the previous reflector (lumens/ reflector=reflector surface area×lumens/area of beam cross section). The optimal configuration can be determined by standard optical engineering programs, inputting the variables of an individual systems beam divergence, desired foot-candles of illumination, and the total desired number of reflectors and their spacing over distance. More generally speaking, for even distribution of light along a beams propagating path, there must be an increased total reflective surface area of a given number of reflectors over a given distance of beam propagation compared to a preceding and subsequent and equivalent given distance.

FIG. 2 shows a second embodiment where condensed beam 3 is progressively intersected by reflectors 18 and 20 above the beam, and reflectors 22 and 24 below the beam, each reflector preferably tilted at about 45 degrees toward the direction of the light beam propagation when downward distribution of the light is desired. Distributed light rays 26 and 28 are shown reflected from reflector 22 for example where they would illuminate a building workspace. Having two groups of tandem reflectors intersecting the beam from two sides both above and below the beam is crucial for keeping the reflectors and propagating beam from undesirable incursion into building space. If the propagating beam were intersected from only above the beam, the reflectors would progressively need to be positioned lower and lower into the building space to intersect the expanding beam, greatly limiting applications of such a distribution method because of the of impractical space requirements. As apparent, the utilized reflector surface area increases progressively as the condensed beam 3 propagates over a given distance 30 to provide substantially equal distribution of light as the cross-sectional energy density of propagating beam 3 decreases due to it's expansion over distance. These tandem reflector surfaces are preferably white substantially paint. Other reflective surfaces such as enhanced reflectivity aluminum, and or curved surfaces specular or semi-specular surfaces may also be utilized, and their unique distribution characteristics derived from state of the art optical engineering programs. It may also be desirable in some applications include additional reflectors oriented at approximately ninety degrees to the horizontal orientation of the reflectors to limit lateral expansion of the beam.

1. A plurality of reflectors where the reflector surfaces successively intersect a beam of light from a plurality of sides of said beam allowing passage of the un-reflected portions of said beam to be re-directed by successive reflectors along said beam's propagating path.

2. Where said beam according to claim 1 is a concentrated and expanding, but substantially collimated beam of sunlight.

3. Where said beam of light referred to in claim 1 is utilized for building illumination.

4. Where the utilized reflector surface areas of said reflectors referred to in claim 1 are matched to the beam's energy density as to re-direct substantially the same total lumens of light per area of building floor space as the previous and or subsequent reflectors over an equal given distance of the propagating path of the beam.

5. Where the utilized surface area of said reflectors according to claim 1 re-directing portions of said beam of light according to claim 3 successively increases over equal compared distance units of said beam's propagation, as the energy density of said beam decreases over distance.

6. Where said reflectors intersecting said beam referred to in claim 3 direct a portion of said beam along a central optical axis that is substantially perpendicular to the optical axis of said beam.

7. Where said reflectors intersecting said beam referred to in claim 6 have an aperture there through allowing passage of the non-reflected portion of said beam.

8. Where the reflector surfaces referred to in claim 7 are substantially elliptical in shape and intersect said beam at an angle that is within a range of about 35 to 55 degrees to the optical axis of said beam.

9. Where the angle of said reflectors referred to in claim 8 intersecting said beam is preferably about 45 degrees.

10. A second embodiment consisting of a plurality of tandem reflectors successively intersecting a beam of light where said tandem reflectors intersect portions of said light beam on substantially opposite sides and allowing passage of the un-reflected portions of the beam to be re-directed by successive reflectors along said beam's propagating path.

11. Where the total lumens of light distributed by said plurality of tandem reflectors referred to in claim 10 over a given distance of beam propagation is substantially equivalent over the total beam propagation distance.

12. Where the utilized surface area of said tandem reflectors referred to in claim 10 redirecting portions of said beam of light beam successively increases over equal compared distance units of said condensed beam's propagation, as the energy density of said beam decreases over distance.

13. Where the total lumens of light distributed by said tandem reflectors referred to in claim 10 over a given distance of beam propagation is substantially equivalent over the total beam propagation distance.

14. Where the length of said tandem reflectors referred to in claim 10 is substantially perpendicular to the optical axis of said beam.

15. Where the angle of the face of said tandem reflectors referred to in claim 10 intersecting said beam is preferably about 45 degrees to the central optical axis of the propagating beam.

16. Where the reflective surface of said tandem reflectors referred to in claim 10 is substantially flat.

17. Where reflective surface of said tandem reflectors referred to in claim 10 is substantially white paint.
